(19) United States
(12) Patent Application Publication
(10) Pub. No.: US 2021/0234422 A1
(43) Pub. Date: Jul. 29, 2021

(54) COOLING SYSTEM FOR VEHICLE ROTARY ELECTRIC MACHINE

(71) Applicant: TOYOTA JIDOSHA KABUSHIKI KAISHA, Toyota-shi (JP)

(72) Inventor: Motoki TAKENO, Nisshin-shi (JP)

(73) Assignee: TOYOTA JIDOSHA KABUSHIKI KAISHA, Toyota-shi (JP)

(21) Appl. No.: 17/071,097

(22) Filed: Oct. 15, 2020

(30) Foreign Application Priority Data
Jan. 27, 2020 (JP) 2020-011260

(51) Int. Cl. H02K 1/32; B60K 11/02; B60K 1/00; H02K 9/19; H02K 11/25

(52) U.S. Cl. CPC H02K 1/32; B60K 11/02; B60K 2001/006; H02K 9/19; H02K 11/25; B60K 1/00

(57) ABSTRACT

An external line that is supplied with oil cooled by a water oil cooler is connected to a first cooling pipe and a second cooling pipe, so oil cooled by the water O/C is supplied to the first cooling pipe and the second cooling pipe. As a result, it is possible to effectively cool a rotary electric machine by using oil that is supplied from the first cooling pipe and the second cooling pipe to the rotary electric machine. The external line that is supplied with oil cooled by the water O/C is connected to the second cooling pipe via a connection fluid passage defined within a case, so the case is cooled by oil. Thus, the influence of outside air temperature on the rotary electric machine is reduced.

### CROSS-REFERENCE TO RELATED APPLICATION

This application claims priority to Japanese Patent Application No. 2020-011260 filed on Jan. 27, 2020, incorporated herein by reference in its entirety.

### BACKGROUND

### 1. Technical Field

The disclosure relates to a structure of a cooling system for a vehicle rotary electric machine, which is capable of effectively cooling a rotary electric machine.

### 2. Description of Related Art

Japanese Unexamined Patent Application Publication No. 2019-062584 (JP 2019-062584 A) describes a structure as a cooling system that cools a rotary electric machine. In the structure, a cooling pipe is disposed radially inward of a rotor of the rotary electric machine provided in a case, and refrigerant is released from the cooling pipe. Japanese Unexamined Patent Application Publication No. 2019-075859 (JP 2019-075859 A) describes a structure in which a cooling pipe is disposed vertically above a rotary electric machine and refrigerant is released from the cooling pipe toward the rotary electric machine.

### SUMMARY

Incidentally, in a structure that employs the structure described in JP 2019-062584 A and the structure described in JP 2019-075859 A at the same time as a cooling system for a rotary electric machine, when refrigerant that has not yet passed through a refrigerant cooler is supplied to cooling pipes, it is difficult to effectively cool the rotary electric machine. When refrigerant is directly supplied from a pipe outside a case to each of the cooling pipes, the temperature of the case increases under the influence of outside air temperature, and the heat of the case is further transferred to the rotary electric machine, with the result that it may be not possible to effectively cool the rotary electric machine.

The disclosure provides a cooling system for a vehicle rotary electric machine, which is capable of effectively cooling a rotary electric machine by suppressing the influence of outside air temperature.

An aspect of the disclosure provides a cooling system for a vehicle rotary electric machine including a stator fixed to a case and a rotor disposed radially inward of the stator. The cooling system includes a first cooling fluid passage disposed vertically above the vehicle rotary electric machine and used to supply refrigerant from above the vehicle rotary electric machine to the vehicle rotary electric machine, a second cooling fluid passage disposed inside a rotary shaft in the rotor and used to supply the refrigerant from an inside of the rotary shaft to the vehicle rotary electric machine, and a refrigerant cooler configured to cool the refrigerant. A refrigerant supply fluid passage configured to be supplied with the refrigerant cooled by the refrigerant cooler is connected to the first cooling fluid passage and the second cooling fluid passage. The refrigerant supply fluid passage is connected to the second cooling fluid passage via a connection fluid passage defined within the case.

In the cooling system according to the aspect of the disclosure, a refrigerant storage part that is a space in which the refrigerant is stored may be defined at an end of the connection fluid passage, to which the second cooling fluid passage is connected, and a temperature sensor may be attached to a wall of the case within which the refrigerant storage part is defined.

In the cooling system according to the aspect of the disclosure, the refrigerant supply fluid passage may have a fluid passage defined within the case and bifurcating into the first cooling fluid passage and the connection fluid passage.

With the cooling system according to the aspect of the disclosure, the refrigerant supply fluid passage that is supplied with refrigerant cooled by the refrigerant cooler is connected to the first cooling fluid passage and the second cooling fluid passage, so the refrigerant cooled by the refrigerant cooler is supplied to the first cooling fluid passage and the second cooling fluid passage. As a result, it is possible to effectively cool the vehicle rotary electric machine by using refrigerant that is supplied to the vehicle rotary electric machine via the first cooling fluid passage and via the second cooling fluid passage. The refrigerant supply fluid passage that is supplied with refrigerant cooled by the refrigerant cooler is connected to the second cooling fluid passage via the connection fluid passage defined within the case, so refrigerant cools the case during the process of passing through the connection fluid passage. As a result, the influence of outside air temperature outside the case on the vehicle rotary electric machine is reduced.

With the cooling system according to the aspect of the disclosure, the refrigerant storage part in which refrigerant is stored is defined at the end of the connection fluid passage, to which the second cooling fluid passage is connected, and the temperature sensor is attached to the wall of the case within which the refrigerant storage part is defined. Therefore, when the temperature of the vehicle rotary electric machine is predicted based on the temperature of refrigerant, since the case is cooled by refrigerant, the influence of outside air temperature is reduced, so the accuracy of predicting the temperature of the vehicle rotary electric machine improves.

With the cooling system according to the aspect of the disclosure, the refrigerant supply fluid passage has the fluid passage defined within the case and bifurcating into the first cooling fluid passage and the connection fluid passage, so it is possible to supply refrigerant, flowing through the refrigerant supply fluid passage, to the first cooling fluid passage and the connection fluid passage.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view for illustrating the structure of a vehicle drive unit included in an electric vehicle to which the disclosure is applied;

FIG. 2 is an enlarged cross-sectional view showing a magnified motor chamber side in which a vehicle rotary electric machine is accommodated in the cross-sectional view of the drive unit of FIG. 1;

FIG. 3 is a diagram that schematically shows the structure of a cooling system that cools the vehicle rotary electric machine;

FIG. 4 is a diagram that schematically shows the structure of a cooling system that is another embodiment of the disclosure; and

FIG. 5 is a diagram that schematically shows the structure of a cooling system that is further another embodiment of the disclosure.

### DETAILED DESCRIPTION OF EMBODIMENTS

Hereinafter, embodiments of the disclosure will be described in detail with reference to the accompanying drawings. In the following embodiments, drawings are simplified or deformed where appropriate, and the scale ratio, shape, and the like of each component are not always drawn accurately.

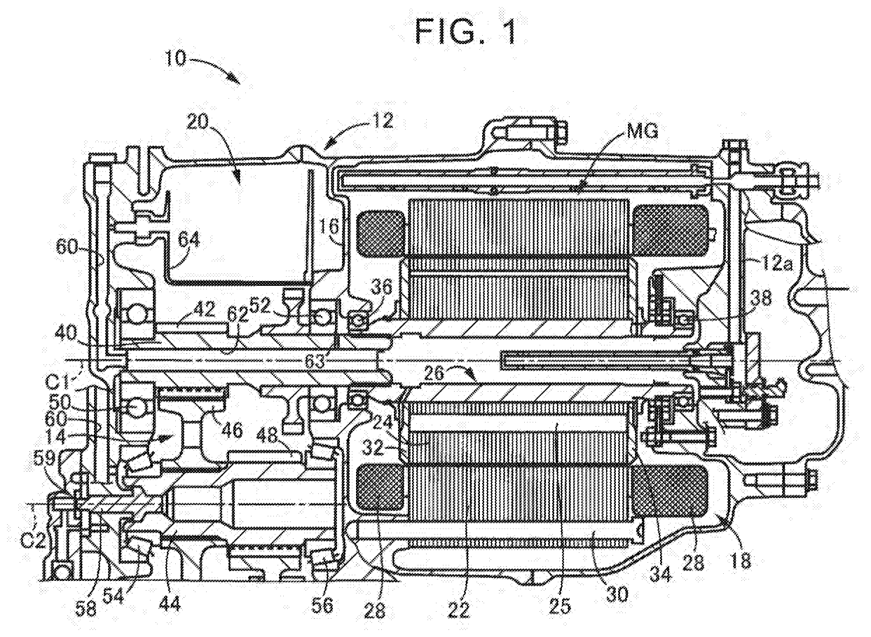

FIG. 1 is a cross-sectional view for illustrating the structure of a vehicle drive unit 10 (hereinafter, drive unit 10) included in an electric vehicle to which the disclosure is applied. The drive unit 10 includes a vehicle rotary electric machine MG (hereinafter, rotary electric machine MG) and a gear mechanism 14 in a case 12 that is a non-rotating member. The rotary electric machine MG functions as a driving force source of the vehicle. The gear mechanism 14 is used to transmit power, to be output from the rotary electric machine MG, to a differential gear (not shown). The power is synonymous with torque and force unless otherwise distinguished.

The inside of the case 12 is partitioned into a motor chamber 18 and a gear chamber 20 by a partition wall 16. The rotary electric machine MG is accommodated in the motor chamber 18. The gear mechanism 14 is accommodated in the gear chamber 20.

The rotary electric machine MG is disposed so as to be rotatable about a rotation axis C1. The rotary electric machine MG includes a cylindrical stator 22, a cylindrical rotor 24, a rotor shaft 26, and coil ends 28. The stator 22 is fixed to the case 12 so as to be non-rotatable. The rotor 24 is disposed radially inward of the stator 22. The rotor shaft 26 is connected integrally with the inner periphery of the rotor 24. The coil ends 28 are wound around the stator 22.

The stator 22 is made up of a plurality of disc steel plates stacked on top of one another. The stator 22 is fixed to the case 12 by a plurality of bolts 30 so as to be non-rotatable. Coils are wound around the stator 22. The coil ends 28 are respectively disposed on both sides of the stator 22 in the direction of the rotation axis C1.

The rotor 24 is disposed radially inward of the stator 22. The rotor 24 is made up of a plurality of disc steel plates stacked on top of one another. End plates 32, 34 are respectively disposed on both sides of the rotor 24 in the direction of the rotation axis C1. The end plates 32, 34 restrict movement of the rotor 24 in the direction of the rotation axis C1. A magnet 25 is embedded in the rotor 24.

The rotor shaft 26 has a cylindrical shape. The rotor shaft 26 is supported by bearings 36, 38 so as to be rotatable about the rotation axis C1. The bearings 36, 38 are respectively disposed at both ends in an axial direction (the direction of the rotation axis C1). The rotor 24 is fixed to the outer peripheral part of the rotor shaft 26 so as to be relatively non-rotatable. Therefore, the rotor 24 and the rotor shaft 26 are integrally rotated about the rotation axis C1.

One end of a power transmission shaft 40 extending through the partition wall 16 is spline-lilted to a gear mechanism 14-side end of the rotor shaft 26 in the axial direction. Therefore, power output from the rotary electric machine MG is transmitted to the power transmission shaft 40.

The gear mechanism 14 includes the power transmission shaft 40, a pinion gear 42, a counter shaft 44, a counter gear 46, and a differential drive gear 48. The power transmission shaft 40 is connected to the rotor shaft 26 of the rotary electric machine MG by spline-fitting. The pinion gear 42 is integrally formed with the power transmission shaft 40. The counter shaft 44 is disposed so as to be rotatable about a rotation axis C2. The counter gear 46 is fixed to the counter shaft 44 and is in mesh with the pinion gear 42. The differential drive gear 48 is integrally formed with the counter shaft 44 and is in mesh with a ring gear of the differential gear (not shown).

The power transmission shaft 40 has a cylindrical shape. The power transmission shaft 40 is disposed in series with the rotor shaft 26. The power transmission shaft 40 is supported by a pair of bearings 50, 52 so as to be rotatable about the rotation axis C1. The bearings 50, 52 are respectively disposed at both ends of the power transmission shaft 40 in the axial direction. The pinion gear 42 is integrally formed with the power transmission shaft 40 and is in mesh with the counter gear 46.

The counter shaft 44 has a cylindrical shape. The counter shaft 44 is disposed about the rotation axis C2 parallel to the rotation axis C1. The counter shaft 44 is supported by a pair of bearings 54, 56 so as to be rotatable about the rotation axis C2. The bearings 54, 56 are respectively disposed at both ends of the counter shaft 44 in the axial direction. The counter gear 46 in mesh with the pinion gear 42 is secured to the counter shaft 44. The differential drive gear 48 in mesh with the ring gear of the differential gear (not shown) is integrally formed with the counter shaft 44. Therefore, when power is output from the rotary electric machine MG, the power is transmitted to the differential gear via the gear mechanism 14.

A pump drive shaft 58 is connected to a bearing 54-side shaft end of the counter shaft 44 in the axial direction. The pump drive shaft 58 is connected to a mechanical oil pump 59 such that power can be transmitted. When the pump drive shaft 58 rotates, the mechanical oil pump 59 is driven. When the mechanical oil pump 59 is driven, oil is discharged to an oil supply fluid passage 60 defined within the case 12. Oil discharged to the oil supply fluid passage 60 is supplied to an axial fluid passage 62 defined within the power transmission shaft 40 or supplied to a catch tank 64 provided at an upper side in the gear chamber 20 in the direction of a vertical line. Oil supplied to the axial fluid passage 62 is, for example, supplied to the bearings 36, 52 via a radial fluid passage 63 that communicates with the axial fluid passage 62. Oil supplied to the catch tank 64 is, for example, supplied to the meshing part and the like between the pinion gear 42 and the counter gear 46 through a release hole (not shown).

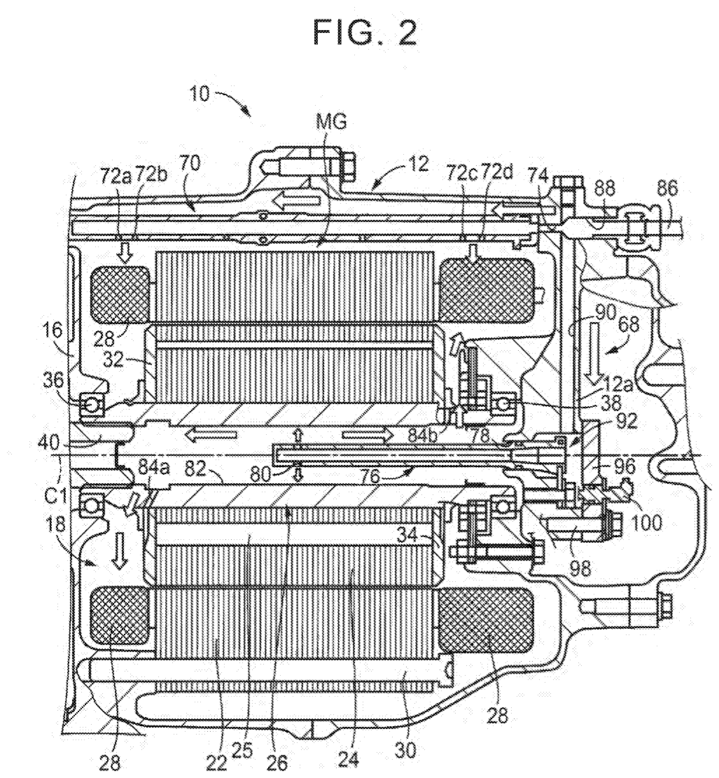

FIG. 2 is an enlarged cross-sectional view showing a magnified motor chamber 18 side in which the rotary electric machine MG is accommodated in the cross-sectional view of the drive unit 10 of FIG. 1. The structure of the cooling system 68 that cools the rotary electric machine MG will be described with reference to the cross-sectional view of FIG. 2. In FIG. 2, the upper side of the sheet corresponds to an upper side in the direction of the vertical line in a vehicle mounted state. In FIG. 2, the outline arrows indicate a direction in which oil flows. Oil may be regarded as refrigerant of the disclosure.

As shown in FIG. 2, a first cooling pipe 70 is disposed vertically above the rotary electric machine MG. The first cooling pipe 70 is disposed such that the longitudinal direction is parallel to the rotation axis C1. The first cooling pipe 70 may be regarded as a first cooling fluid passage of the disclosure.

An opening provided at one end of the first cooling pipe 70 in the direction of the rotation axis C1 is connected to a first communication hole 74 defined within the case 12. Oil flows into the first cooling pipe 70 through the first communication hole 74. Oil flowing into the first cooling pipe 70 is, for example, released from release holes 72a, 72b, 72c, 72d formed in the first cooling pipe 70, with the result that oil is supplied from above the rotary electric machine MG to the coil ends 28 respectively located on both sides of the stator 22 in the direction of the rotation axis C1. In this way, the first cooling pipe 70 is provided so as to supply oil from above the rotary electric machine MG to the rotary electric machine MG.

A second cooling pipe 76 is disposed radially inward of the rotor 24 of the rotary electric machine MG, that is, inside the rotor shaft 26 in the rotor 24. The second cooling pipe 76 is disposed such that the longitudinal direction is parallel to the rotation axis C1. An open end, in the longitudinal direction, of the second cooling pipe 76 is fixed in a state of being fitted in a second communication hole 78 formed in the case 12. Oil flows into the second cooling pipe 76 via a connection fluid passage 90 (described later). The second cooling pipe 76 is disposed below the first cooling pipe 70 in the direction of the vertical line. The second cooling pipe 76 may be regarded as a second cooling fluid passage of the disclosure. The rotor shaft 26 may be regarded as a rotary shaft of the disclosure.

Oil flowing into the second cooling pipe 76 is released to the outside of the second cooling pipe 76 via release holes 80 formed in the second cooling pipe 76. Oil released to the outside of the second cooling pipe 76 moves along an axial hole 82 of the rotor shaft 26 and is supplied to the coil ends 28 and the like via radial holes 84a, 84b that communicate the outer periphery of the rotor shaft 26 with the axial hole 82. In this way, the second cooling pipe 76 is provided to supply oil from the inside of the rotor shaft 26 (the radially inner side of the rotor 24) to the rotary electric machine MG.

Oil is supplied from an external line 86 to the first cooling pipe 70 and the second cooling pipe 76. The external line 86 is connected to an oil inflow fluid passage 88 defined within the case 12. Thus, oil flows from the external line 86 into the oil inflow fluid passage 88. An opposite side of the oil inflow fluid passage 88 from the side connected to the external line 86 bifurcates into the first communication hole 74 that communicates with the first cooling pipe 70 and the connection fluid passage 90 connected to the second cooling pipe 76. Thus, oil flowing from the external line 86 into the oil inflow fluid passage 88 is supplied to the first cooling pipe 70 via the first communication hole 74 and is also supplied to the second cooling pipe 76 via the connection fluid passage 90. The external line 86 and the oil inflow fluid passage 88 may be regarded as a refrigerant supply fluid passage of the disclosure. The oil inflow fluid passage 88 may be regarded as a fluid passage of the disclosure, defined within a case and bifurcating into a first cooling fluid passage and a connection fluid passage. As shown in FIG. 2, the oil inflow fluid passage 88, the first communication hole 74, and the first cooling pipe 70 are located in alignment in the direction of the rotation axis C1. In other words, the oil inflow fluid passage 88, the first communication hole 74, and the first cooling pipe 70 are located at the same level in the direction of the vertical line.

The connection fluid passage 90 that connects the oil inflow fluid passage 88 and the second cooling pipe 76 is defined inside a wall part 12a provided perpendicularly to the rotation axis C1 of the case 12. The connection fluid passage 90 extends in a radial direction of the rotary electric machine MG and connects the oil inflow fluid passage 88 and the second cooling pipe 76. Since the oil inflow fluid passage 88 bifurcates into the first communication hole 74 and the connection fluid passage 90, the external line 86 is connected to the first cooling pipe 70 via the oil inflow fluid passage 88 and the first communication hole 74 and is also connected to the second cooling pipe 76 via the oil inflow fluid passage 88 and the connection fluid passage 90. Therefore, part of oil flowing into the oil inflow fluid passage 88 is supplied to the first cooling pipe 70 via the first communication hole 74, and the remaining part of oil flowing into the oil inflow fluid passage 88 is supplied to the second cooling pipe 76 via the connection fluid passage 90.

An oil storage part 92 is defined at an end of the connection fluid passage 90, in a direction in which oil flows, that is, an end of the connection fluid passage 90, connected to the second cooling pipe 76. The oil storage pan 92 is a space defined such that a recess formed within the wall part 12a of the case 12 is covered with a cover 96. The cover 96 is fastened by a bolt 98. Since the cover 96 is integrally connected to the wall pan 12a of the case 12, the cover 96 functions as part of the case 12. The cover 96 may be regarded as a wall of a case in which a refrigerant storage part is formed according to the disclosure.

Part of the opening-side one end of the second cooling pipe 76 is accommodated in the oil storage pan 92. Oil flowing into the oil storage part 92 via the connection fluid passage 90 temporarily stagnates in the oil storage part 92 and flows into the second cooling pipe 76 via the opening of the second cooling pipe 76. The oil storage part 92 may be regarded as a refrigerant storage part of the disclosure.

A temperature sensor 100 is attached to the cover 96 inside which the oil storage part 92 is defined. The temperature sensor 100 detects the fluid temperature of oil. Therefore, the fluid temperature of oil to be stored in the oil storage part 92 is detected by the temperature sensor 100. In the present embodiment, the temperature (magnet temperature) of the magnet 25 embedded in the rotary electric machine MG is predicted based on the fluid temperature of oil, detected by the temperature sensor 100.

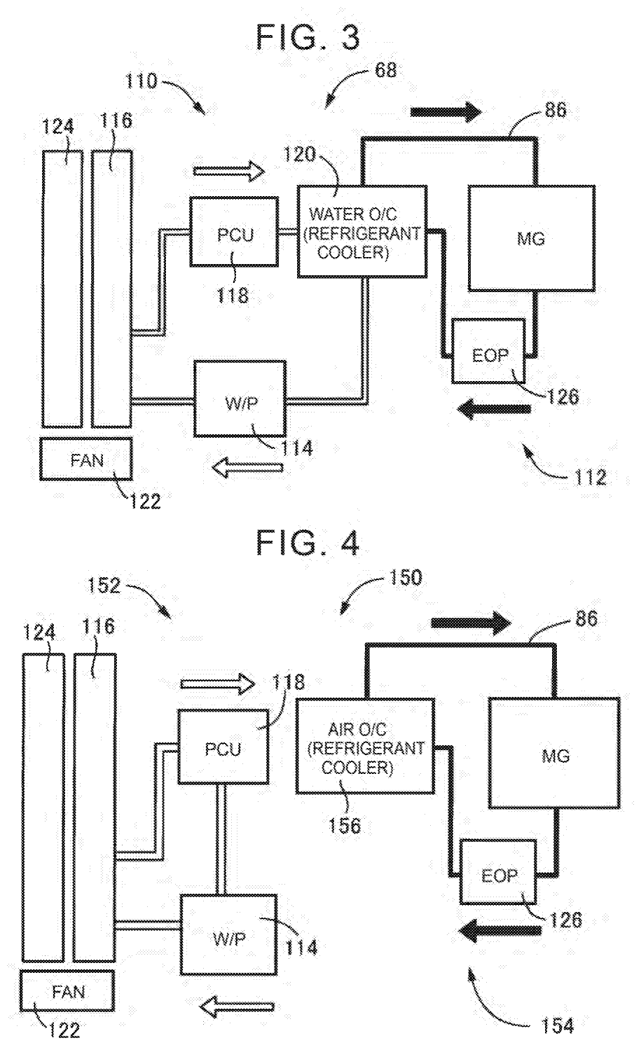

Oil cooled by a water oil cooler 120 (see FIG. 3) (described later) is supplied to the external line 86. Therefore, oil cooled by the water oil cooler 120 is supplied to the first cooling pipe 70 and the second cooling pipe 76 via the external line 86. As a result, the rotary electric machine MG is supplied with cooled oil, so the rotary electric machine MG is effectively cooled.

FIG. 3 simply show s the configuration of a cooling system 68 that cools the rotary electric machine MG. As shown in FIG. 3, the cooling system 68 includes a coolant circulation circuit 110 in which coolant is circulated and an oil circulation circuit 112 in which oil is circulated.

The coolant circulation circuit 110 is configured such that coolant circulates among a water pump 114 (hereinafter, W/P 114), a radiator 116, a power control unit 118 (hereinafter, PCU 118) that controls the operation of the rotary electric machine MG, and the water oil cooler 120 (hereinafter, water O/C 120) that cools oil. A direction in which coolant flows corresponds to the directions of the outline arrows. The water oil cooler 120 may be regarded as a refrigerant cooler of the disclosure.

In the coolant circulation circuit 110, when the W/P 114 is driven, coolant is fed from the W/P 114 to the radiator 116 as indicated by the outline arrows. Coolant fed to the radiator 116 releases heat to the outside in process of passing through the radiator 116 to be cooled. A fan 122 (FAN) is driven to forcibly cool coolant that passes through the radiator 116. A condenser 124 of an air-conditioner (not shown) is also forcibly cooled by the fan 122. Since the radiator 116 is a known technique, detailed description on structure and operation is omitted.

Coolant cooled by the radiator 116 is fed to the PCU 118 to cool the PCU 118. Furthermore, coolant having passed through the PCU 118 is fed to the water O/C 120. The water O/C 120 is configured to be capable of exchanging heat between coolant flowing through the coolant circulation circuit 110 and oil flowing through the oil circulation circuit 112. Oil is cooled by releasing heat to coolant. Coolant having passed through the water O/C 120 is returned to the W/P 114, so coolant circulates in the coolant circulation circuit 110. Since the water O/C 120 is a known technique, detailed description on structure and operation is omitted.

The oil circulation circuit 112 is configured such that oil circulates among an electric oil pump 126 (hereinafter, EOP 126), the water O/C 120, and the rotary electric machine MG included in the vehicle drive unit 10. The direction of flow of oil in the oil circulation circuit 112 corresponds to the directions of the solid arrows.

In the oil circulation circuit 112, when the EOP 126 is driven, oil is fed from the EOP 126 to the water O/C 120. Oil fed to the water O/C 120 releases heat in process of passing through the water O/C 120 to be cooled. Oil cooled by the water O/C 120 is supplied to the rotary electric machine MG included in the drive unit 10 to cool the rotary electric machine MG. Oil having cooled the rotary electric machine MG is returned to the EOP 126, so oil circulates in the oil circulation circuit 112.

The fluid passage that connects the water O/C 120 and the rotary electric machine MG, shown in FIG. 3, corresponds to the external line 86 of FIG. 2. Therefore, oil cooled by the water O/C 120 is supplied to the external line 86, further passes through the oil inflow fluid passage 88 defined within the case 12 shown in FIG. 2 via the external line 86, and is supplied to the first cooling pipe 70 and the second cooling pipe 76. In this way, oil cooled through the water O/C 120 is supplied to both the first cooling pipe 70 and the second cooling pipe 76, so the rotary electric machine MG is effectively cooled. In other words, since oil does not pass through the gear chamber 20 or the like between the water O/C 120 and the oil inflow fluid passage 88, sufficiently cooled oil is supplied to any of the first cooling pipe 70 and the second cooling pipe 76, with the result that the rotary electric machine MG is effectively cooled.

Part of oil having flowed into the oil inflow fluid passage 88 passes through the connection fluid passage 90 and reaches the oil storage part 92 defined at a position just before being supplied to the second cooling pipe 76 (that is, the rotary electric machine MG). Oil cooled by the water O/C 120 cools the case 12 in process of passing through the connection fluid passage 90 of the case 12. In this way, the case 12 is cooled by oil, so an increase in the temperature of the case 12 under the influence of outside air temperature is suppressed. As a result, the rotary electric machine MG does not receive the influence of outside air temperature via the case 12. In predicting the magnet temperature of the rotary electric machine MG based on the fluid temperature of oil, detected by the temperature sensor 100, the rotary electric machine MG does not receive the influence of outside air temperature, so the accuracy of predicting the magnet temperature of the rotary electric machine MG by using the temperature sensor 100 improves.

As described above, according to the present embodiment, the external line 86 and the oil inflow fluid passage 88, which are supplied with oil cooled by the water O/C 120, are connected to the first cooling pipe 70 and the second cooling pipe 76. Therefore, oil cooled by the water O/C 120 is supplied to the first cooling pipe 70 and the second cooling pipe 76, so it is possible to effectively cool the rotary electric machine MG with oil that is supplied to the rotary electric machine MG via the first cooling pipe 70 and the second cooling pipe 76. The external line 86 and the oil inflow fluid passage 88, which are supplied with oil cooled by the water O/C 120, are connected to the second cooling pipe 76 via the connection fluid passage 90 defined within the case 12. Therefore, oil cools the case 12 in process of passing through the connection fluid passage 90. As a result, the influence of outside air temperature outside the case 12 on the rotary electric machine MG is also reduced.

According to the present embodiment, the oil storage part 92 in which oil is stored is defined at the end of the connection fluid passage 90, to which the second cooling pipe 76 is connected, and the temperature sensor 100 is attached to the cover 96 inside which the oil storage part 92 is defined. Therefore, when the magnet temperature of the rotary electric machine MG is predicted based on the temperature of oil, since the case 12 is cooled by refrigerant, the influence of outside air temperature is reduced, so the accuracy of predicting the magnet temperature of the rotary electric machine MG improves. The oil inflow fluid passage 88 includes the fluid passage defined within the case 12 and bifurcating into the first cooling pipe 70 and the connection fluid passage 90. Therefore, it is possible to supply oil flowing through the oil inflow fluid passage 88 to the first cooling pipe 70 and the connection fluid passage 90.

Next, another embodiment of the disclosure will be described Like reference signs denote portions common to the above-described embodiment in the following description, and the description thereof will not be repeated.

FIG. 4 simply shows the structure of a cooling system 150 that cools the rotary electric machine MG and that is another embodiment of the disclosure. The cooling system 150, as in the case of the above-described embodiment, is provided in the drive unit 10 for an electric vehicle. The cooling system 150 includes a coolant circulation circuit 152 and an oil circulation circuit 154.

The coolant circulation circuit 152 is configured such that coolant circulates among the water pump 114 (hereinafter, W/P 114), the radiator 116, and the power control unit 118 (hereinafter, PCU 118). The direction of flow of coolant in the coolant circulation circuit 152 corresponds to the directions of the outline arrows.

In the coolant circulation circuit 152, when the W/P 114 is driven, coolant is fed from the W/P 114 to the radiator 116. Coolant fed to the radiator 116 releases heat to the outside in process of passing through the radiator 116 to be cooled. When coolant cooled by the radiator 116 is fed to the PCU 118, the PCU 118 is cooled. Coolant having cooled the PCU MS is returned to the W/P 114, so coolant circulates in the coolant circulation circuit 152.

The oil circulation circuit 154 is configured such that oil circulates among the electric oil pump 126 (hereinafter, EOP 126), an air oil cooler 156 (hereinafter, air O/C 156), and the rotary electric machine MG. The direction of flow of oil in the oil circulation circuit 154 corresponds to the directions of the solid arrows.

In the oil circulation circuit 154, when the POP 126 is driven, oil is fed from the EOP 126 to the air O/C 156. Oil fed to the air O/C 156 exchanges heat with outside air to be cooled. Since the air O/C 156 is a known technique, detailed description on structure and operation is omitted.

Oil cooled by the air O/C 156 is supplied to the rotary electric machine MG through the external line 86. Therefore, the rotary electric machine MG is cooled by oil cooled via the air O/C 156. Oil having cooled the rotary electric machine MG is returned to the EOP 126, so oil circulates in the oil circulation circuit 154.

In this way, even with the structure in which oil is cooled with the air O/C 156 instead of the water O/C 120 of the above-described first embodiment, oil cooled by the air O/C 156 is supplied to the rotary electric machine MG, so the rotary electric machine MG is effectively cooled. Therefore, in the present embodiment as well, similar advantageous effects to those of the above-described embodiment are obtained.

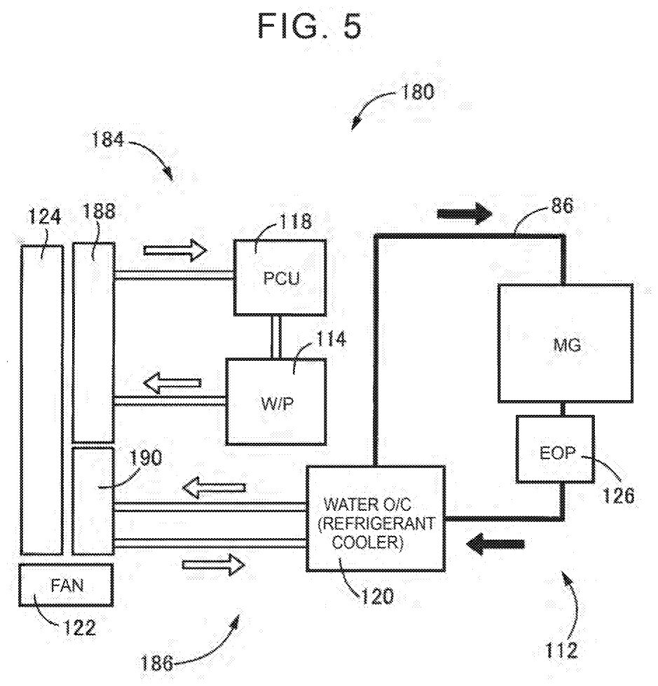

FIG. 5 simply shows the structure of a cooling system 180 that cools the rotary electric machine MG and that is further another embodiment of the disclosure. The cooling system 180, as in the case of the above-described embodiments, is provided in the drive unit 10 for an electric vehicle. The cooling system 180 includes a first coolant circulation circuit 184, a second coolant circulation circuit 186, and the oil circulation circuit 112. The oil circulation circuit 112 is basically the same as that of the above-described first embodiment, so like reference signs are assigned, and the description thereof is omitted.

The first coolant circulation circuit 184 is configured such that coolant circulates among the water pump 114 (hereinafter, W/P 114), a first radiator 188, and the power control unit 118 thereinafter, PCU 118).

When the W/P 114 is driven, coolant is fed from the W/P 114 to the first radiator 188. Coolant fed to the first radiator 188 is cooled in process of passing through the first radiator 188. Coolant cooled by the first radiator 188 is fed to the PCU 118. Therefore, the PCU 118 is cooled by coolant. Coolant having cooled the PCU 118 is returned to the W/P 114, so coolant circulates in the first coolant circulation circuit 184.

The second coolant circulation circuit 186 is configured such that coolant circulates between the water oil cooler 120 (hereinafter, water O/C 120) and a second radiator 190. Therefore, coolant cooled by the second radiator 190 flows into the water O/C 120. The water O/C 120 is configured to be capable of exchanging heat between coolant flowing through the second coolant circulation circuit 186 and oil flowing through the oil circulation circuit 112. Oil flowing through the oil circulation circuit 112 is cooled by releasing heat to coolant.

Oil cooled by the water O/C 120 is supplied through the external line 86 to the oil inflow fluid passage 88 (see FIG. 2) defined within the case 12 of the drive unit 10. Therefore, oil cooled by the water O/C 120 is supplied to the first cooling pipe 70 and the second cooling pipe 76 via the oil inflow fluid passage 88, so the rotary electric machine MG is effectively cooled. In this way, in the present embodiment as well, similar advantageous effects to those of the above-described embodiments are obtained.

The embodiments of the disclosure are described in detail with reference the drawings; however, the disclosure is also applicable to other embodiments.

For example, in the above-described embodiments, the cooling systems 68, 150, 180 are applied to the drive unit 10 for an electric vehicle; however, the disclosure is not necessarily limited to the application to the drive unit 10 for an electric vehicle. The disclosure may also be applied to, for example, a drive unit for a hybrid vehicle that uses an engine and a rotary electric machine as driving force sources.

In the above-described embodiments, oil flowing through the oil circulation circuit 112 is circulated by the electric oil pump 126. Alternatively, oil may be circulated by, for example, another-type oil pump, such as a mechanical oil pump that is driven by the power transmission shaft 40.

In the above-described embodiments, the water oil cooler 120 is disposed outside the drive unit 10. Alternatively, a water oil cooler may be disposed inside the drive unit 10. In relation to this, the fluid passage that connects the water oil cooler and the rotary electric machine MG may also be disposed inside the drive unit 10.

In the above-described embodiments, the first cooling pipe 70 and the second cooling pipe 76 are made up of members different from the case 12; however, the first cooling pipe 70 and the second cooling pipe 76 are not necessarily limited to the modes of the present embodiments. The first cooling pipe 70 and the second cooling pipe 76 may be modified as needed as long as the first cooling pipe 70 and the second cooling pipe 76 are able to supply oil to the rotary electric machine MG. For example, the first cooling pipe 70 may be provided integrally with the case 12 as part of the fluid passage defined within the case 12.

The above-described embodiments are only illustrative. The disclosure may be implemented in modes including various modifications or improvements based on the knowledge of persons skilled in the art.

What is claimed is:

1. A cooling system for a vehicle rotary electric machine including a stator fixed to a case and a rotor disposed radially inward of the stator, the cooling system comprising:
a first cooling fluid passage disposed vertically above the vehicle rotary electric machine and used to supply refrigerant from above the vehicle rotary electric machine to the vehicle rotary electric machine;
a second cooling fluid passage disposed inside a rotary shaft in the rotor and used to supply the refrigerant from an inside of the rotary shaft to the vehicle rotary electric machine; and
a refrigerant cooler configured to cool the refrigerant, wherein:
a refrigerant supply fluid passage configured to be supplied with the refrigerant cooled by the refrigerant cooler is connected to the first cooling fluid passage and the second cooling fluid passage; and
the refrigerant supply fluid passage is connected to the second cooling fluid passage via a connection fluid passage defined within the case.

2. The cooling system according to claim 1, wherein:
a refrigerant storage part that is a space in which the refrigerant is stored is defined at an end of the connection fluid passage, to which the second cooling fluid passage is connected; and
a temperature sensor is attached to a wall of the case within which the refrigerant storage part is defined.

3. The cooling system according to claim 1, wherein the refrigerant supply fluid passage has a fluid passage defined within the case and bifurcating into the first cooling fluid passage and the connection fluid passage.
